(19) United States
(12) Patent Application Publication
(10) Pub. No.: US 2003/0026932 A1
(43) Pub. Date: Feb. 6, 2003

(54) Multilayer laminate

(76) Inventors: John R. Johnson, Valparaiso, IN (US); Richard L. Sandt, Brunswick, OH (US)

Correspondence Address: Armand P. Boisselle, Renner, Otto, Boisselle, & Sklar, L.L.P., 19th Floor, 1621 Euclid Avenue, Cleveland, OH, 44115, US

(21) Appl. No.: 09/918,134

(22) Filed: Jul. 30, 2001

(51) Int. Cl. B32B 7/06

(52) U.S. Cl. 428/40.1; 428/354; 428/203

(57) ABSTRACT

Metallized multilayer laminates are described which provide a bright reflective finish on deformable articles, such as impact absorbing bumpers of automobiles and also provide bright reflective surfaces on molded parts or three-dimensional shapes as an alternative to chrome plating. In one embodiment, the multilayer laminates of the present invention comprise:

(A) a base layer having a first-surface and a second surface, and comprising a metallizable polymer,

(B) a metal layer having a first-surface and a second surface wherein the first surface of the metal layer is in contact with and adhered to the second surface of the base layer,

(C) a clear polymer topcoat layer having a first-surface and a second surface wherein the second surface is in contact with and adhered to the first surface of the base layer, and

(D) a first adhesive layer having a first surface and a second surface wherein the first surface of the adhesive layer is in contact with and adhered to the second surface of the metal layer.

### FIELD OF THE INVENTION

This invention relates to multilayer laminates. More particularly, the invention relates to reflective metal multilayer laminates which can be bonded to various substrates, including exterior automotive panels, as a protective and/or decorative covering.

### BACKGROUND OF THE INVENTION

Metallized films can be produced by various techniques such as the vacuum metallizing process. The principal of the vacuum metallizing process lies in heating a metal such as aluminum, nickel, chromium or alloys thereof, etc. in high vacuum equipment at temperatures higher than its melting point to cause the metal to vaporize, radiating and condensing the metal on a cooled substrate to be metallized such as onto plastic films, thereby forming thin layers of the metal. The metallized films thus produced find application in decorative materials, the electrical industry, agriculture, packaging systems, etc.

In the past, highly reflective metal surfaces have been used on many decorative articles. A typical use is in metal bumpers and trim parts for automobiles. Chrome plating is generally used because of its high reflectivity, corrosion resistance, and abrasion resistance.

The reflective metal trim parts on automobiles are typically made from metal castings which are chrome-plated and commonly attached to the automobile body by metal clips or fasteners. The disadvantages of such trim parts include the additional weight added to the automobile, time-consuming and relatively expensive attachment techniques, and corrosion problems resulting because the trim parts are made from a metal which is different from that of the automotive body and thereby causes corrosion from electroylsis of the disimilar metals. Despite these problems, chrome-plated metal trim parts continue in use today, at least in part because of the relative ease in which differently shaped surface configurations can be plated with highly reflective, abrasion resistant and corrosion-resistant metal such as chromium.

### SUMMARY OF THE INVENTION

Metallized multilayer laminates are described which provide a bright reflective finish on deformable articles, such as impact absorbing bumpers of automobiles and also provide bright reflective surfaces on molded parts or three-dimensional shapes as an alternative to chrome plating. In one embodiment, the multilayer laminates of the present invention comprise:

(A) a base layer having a first-surface and a second surface, and comprising a metallizable polymer,

(B) a metal layer having a first-surface and a second surface wherein the first surface of the metal layer is in contact with and adhered to the second surface of the base layer,

(C) a clear polymer topcoat layer having a first-surface and a second surface wherein the second surface is in contact with and adhered to the first surface of the base layer, and

(D) an adhesive layer having a first surface and a second surface wherein the first surface of the adhesive layer is in contact with and adhered to the second surface of the metal layer.

In another embodiment, the metallized multilayer laminate of the present invention has an exterior distinctness of image (DOI) value of at least 80 and comprises:

(A) a base layer having a first-surface and a second surface, and comprising a metallizable polymer,

(B) a metal layer having a first-surface and a second surface wherein the first surface of the metal layer is in contact with and adhered to the second surface of the base layer,

(C) a polymer tie layer having a first surface and a second surface wherein the second surface of the tie layer is in contact with and adhered to the first surface of the base layer,

(D) a clear polymer topcoat layer having a first surface and a second surface wherein the second surface of the clear topcoat layer is in contact with and adhered to the first surface of the tie coat layer,

(E) an adhesive layer having a first surface and a second surface wherein the first surface of the adhesive layer is in contact with and adhered to the second surface of the metal layer.

In yet another embodiment, the metallized multilayer laminates of the present invention comprise:

(A) a base layer having a first-surface and a second surface, and comprising a metallizable polymer,

(B) a metal layer having a first-surface and a second surface wherein the first surface of the metal layer is in contact with and adhered to the second surface of the base layer,

(C) a first adhesive layer having a first surface and a second surface wherein the first surface of the first adhesive layer is in contact with and adhered to the second surface of the metal layer,

(D) a second pressure sensitive adhesive layer having a first surface and a second surface wherein the second surface of the second pressure sensitive adhesive layer is in contact with and adhered to the first surface of the base layer,

(E) a clear polymer layer having a first surface and a second surface wherein the second surface of the clear polymer layer is in contact with and adhered to the first surface of the second pressure sensitive adhesive layer,

(F) a polymer tie coat layer having a first surface and a second surface wherein the second surface of the tie coat layer is in contact with and adhered to the first surface of the clear polymer layer, and

(G) a clear polymer topcoat layer having a first surface and a second surface wherein the second surface of the clear topcoat layer is in contact with and adhered to the first surface of the tie coat layer.

These and other embodiments of the invention are more fully described below and can be fully understood by referring to said description and the accompanying drawings.

### BRIEF DESCRIPTION OF THE DRAWINGS

FIG. 1 is a schematic cross-sectional view illustrating one embodiment of the multilayer laminates according to the present invention. Film thicknesses are exaggerated for simplicity.

FIGS. 2-9 are further schematic cross-sectional views illustrating various embodiments of the multilayer laminates of the present invention.

### DETAILED DESCRIPTION OF THE INVENTION

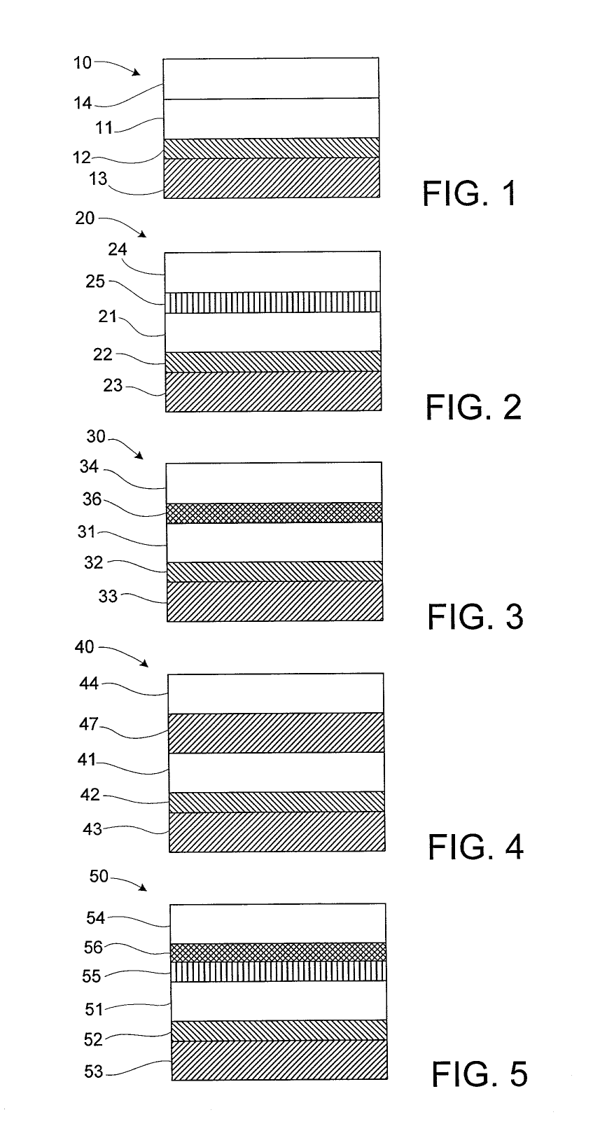

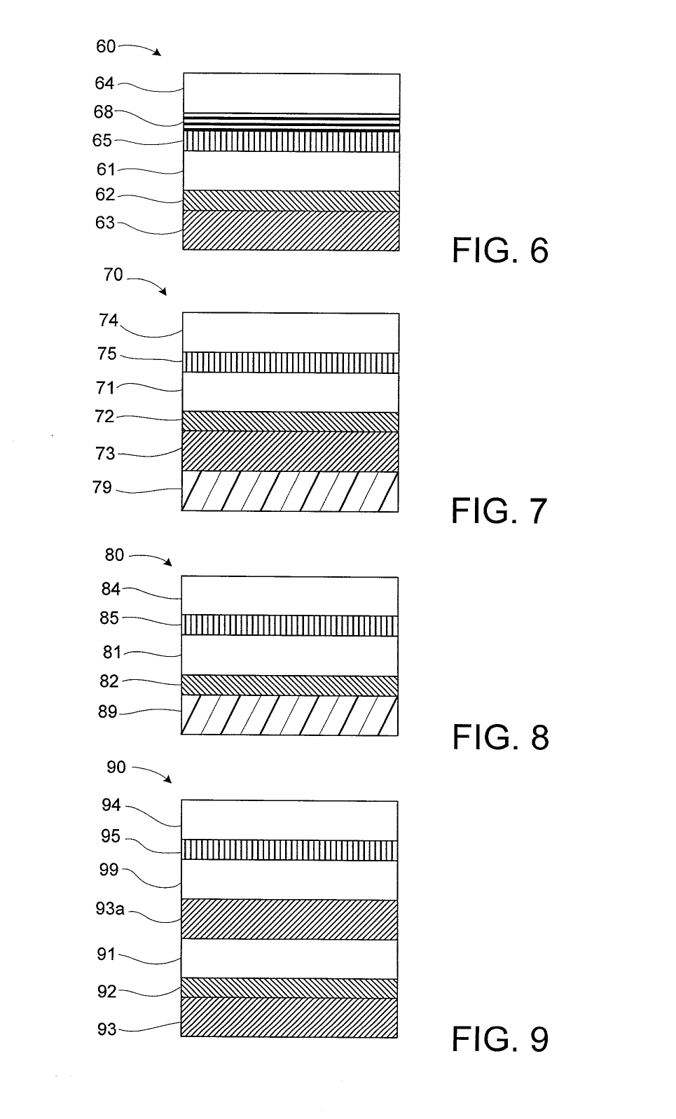

Various embodiments of the invention are illustrated in FIGS. 1-9. These figures illustrate the various layers that may comprise the multilayer laminates of the present invention. Referring to FIG. 1, a multilayer laminate 10 according to this embodiment, includes a base layer 11 having a first surface and a second surface, a metal layer 12 having a first surface and a second surface wherein the first surface of the metal layer 12 is in contact with and adhered to the second surface of the base layer, an adhesive layer 13 having a first surface and a second surface wherein the first surface of the adhesive layer 13 is in contact with an adhered to the second surface of the metal layer 12, and a clear topcoat layer 14 having a first surface and a second surface wherein the second surface of the topcoat layer 14 is in contact with and adhered to the first surface of the base layer 11. The compositions of the various layers of the construction 10 of FIG. 1, as well as the layers of the constructions of FIGS. 2-9 will be discussed in more detail below following this brief discussion of the figures.

Referring to FIG. 2, a multilayer laminate 20 is illustrated which comprises a base layer 21 having a first surface and a second surface, a metal layer 22 having a first surface and a second surface wherein the first surface of the metal layer 22 is in contact with and adhered to the second surface of the base layer 21, an adhesive layer 23 having a first surface and a second surface wherein the first surface of the adhesive layer 23 is in contact with and adhered to the second surface of the metal layer 22, a tie coat layer 25 having a first surface and a second surface wherein the second surface of the tie coat layer 25 is in contact with and adhered to the first surface of the base layer 21, and a topcoat layer 24 having a first surface and a second surface wherein the second surface of the topcoat layer 24 is in contact with and adhered to the first surface of the tie coat layer 25.

FIG. 3 illustrates another embodiment of the multilayer laminates of the present invention which comprises a base layer 31 having a first surface and a second surface, a metal layer 32 having a first surface and a second surface wherein the first surface of the metal layer 32 is in contact with and adhered to the second surface of the base layer, an adhesive layer 33 having a first surface and a second surface, wherein the first surface of the adhesive layer is in contact with and adhered to the second surface of the metal layer, a barrier layer 36 having a first surface and a second surface wherein the second surface of the barrier layer 36 is in contact with the first surface of the base layer 31, and a topcoat layer 34 having a first surface and a second surface, wherein the second surface of the topcoat layer 34 is in contact with and adhered to the first surface of the barrier layer 36.

FIG. 4 illustrates another embodiment of the multilayer laminates of the present invention. The multilayer laminate 40 comprises a base layer 41 having a first surface and a second surface, a metal layer 42 having a first surface and a second surface wherein the first surface of the metal layer 42 is in contact with and adhered to the second surface of the base layer 41, a first adhesive layer 43 having a first surface and a second surface wherein the first surface of the first adhesive layer 43 is in contact with and adhered to the second surface of the metal layer 42, a second PSA layer 47 having a first surface and a second surface wherein the second surface of the second PSA layer 47 is in contact with and adhered to the first surface of the base layer 41, and a topcoat layer 44 having a first surface and a second surface wherein the second surface of the topcoat layer 44 is in contact with and adhered to the first surface of the second PSA layer 47. This embodiment provides a method of improving the adhesion of the topcoat layer 44 to the base layer 41 when desired or necessary.

The multilayer laminate 50 of the embodiment illustrated in FIG. 5 includes a base layer 51 having a first surface and a second surface, a metal layer 52 having a first surface and a second surface, wherein the first surface of the metal layer 52 is in contact with and adhered to the second surface of the base layer 51, an adhesive layer 53 having a first surface and a second surface wherein the first surface of the adhesive layer 53 is in contact with and adhered to the second surface of the metal layer 52, a tie coat layer 55 having a first surface and a second surface wherein the second surface of the tie coat layer 55 is in contact with and adhered to the first surface of the base layer 51, a barrier layer 56 having a first surface and a second surface wherein the second surface of the barrier layer 56 is in contact with and adhered to the first surface of the tie coat layer 55, and a topcoat layer 54 having a first surface and a second surface wherein the second surface of the topcoat layer 54 is in contact with and adhered to the first surface of the barrier layer 56. This embodiment provides a method for improving the adhesion of a barrier layer to the base layer and provides a barrier layer to prevent migration of, for example, plasticizers which may be present in the topcoat layer, particularly when the topcoat layer comprises polyvinyl chloride (PVC).

FIG. 6 illustrates another embodiment of the multilayer composites of the present invention wherein one of the layers is an ink layer. In particular, the multilayer laminate 60 illustrated in FIG. 6 includes a base layer 61 having a first surface and a second surface, a metal layer 62 having a first surface and a second surface wherein the first surface of the metal layer 62 is in contact with the second surface of the base layer 61, an adhesive layer 63 having a first surface and a second surface wherein the first surface of the adhesive layer 63 is in contact with and adhered to the second surface of the metal layer 62, a tie coat layer 65 having a first surface and a second surface, wherein the second surface of the tie coat layer 65 is in contact with and adhered to the first surface of the base layer 61, an ink layer 68 having a first surface and a second surface, wherein the second surface of the ink layer 68 is in contact with and adhered to the first surface of the tie coat layer 65, and a topcoat layer 64 having a first surface and a second surface wherein the second surface of the topcoat layer 64 is in contact with and adhered to the first surface of the ink layer 68.

The embodiment illustrated in FIG. 7 illustrates a multilayer laminate 70 which includes a base layer 71 having a first surface and a second surface, a metal layer 72 having a first surface and a second surface wherein the first surface of the metal layer 72 is in contact with and adhered to the second surface of the base layer 71, an adhesive layer 73 having a first surface and a second surface wherein the first surface of the adhesive layer 73 is in contact with and adhered to the second surface of the metal layer 72, a polyvinyl halide layer 79 having a first surface and a second surface wherein the first surface of the polyvinyl halide layer 79 is in contact with and adhered to the second surface of the PSA layer 73, a tie coat layer 75 having a first surface and a second surface wherein the second surface of the tie coat layer is in contact with and adhered to the first surface of the base layer 71, and a topcoat layer 74 having a first surface and a second surface wherein the second surface of the topcoat layer 74 is in contact with and adhered to the first surface of the tie coat layer 75.

The multilayer composite illustrated in FIG. 8 differs from the embodiments illustrated above in that the adhesive layer is replaced by polyvinyl halide layer. In particular, the embodiment illustrated in FIG. 8 illustrate a multilayer laminate 80 which includes a base layer 81 having a first surface and a second surface, a metal layer 82 having a first surface and a second surface wherein the first surface of the metal layer 82 is in contact with and adhered to the second surface of the base layer 81, a polyvinyl halide layer 89 having a first surface and a second surface wherein the first surface of the polyvinyl halide layer 89 is in contact with and adhered to the second surface of the metal layer, a tie coat layer 85 having a first surface and a second surface wherein the second surface of the tie coat layer 85 is in contact with and adhered to the first surface of the base layer 81, and a topcoat layer 84 having a first surface and a second surface wherein the second surface of the topcoat layer 84 is in contact with and adhered to the first surface of the tie coat layer 85.

FIG. 9 illustrates another embodiment wherein the multilayer laminate 90 includes a base layer 91 having a first surface and a second surface, a metal layer 92 having a first surface and a second surface wherein the first surface of the metal layer 92 is in contact with and adhered to the second surface of the base layer 91, a first adhesive layer 93 having a first surface and a second surface wherein the first surface of the first adhesive layer 93 is in contact with and adhered to the second surface of the metal layer 92, a second PSA layer 93a having a first surface and a second surface wherein the second surface of the second PSA layer 93a is in contact with and adhered to the first surface of the base layer 91, a clear coat layer 99 having a first surface and a second surface wherein the second surface of the clear coat layer 99 is in contact with and adhered to the first surface of the second PSA layer 93a, a tie coat layer 95 having a first surface and a second surface wherein the second surface of the tie coat layer 95 is in contact with and adhered to the first surface of the clear coat layer 99, and a topcoat layer 94 having a first surface and a second surface wherein the second surface of the topcoat layer 94 is in contact with and adhered to the first surface of the tie coat layer 95. This embodiment illustrates a multilayer laminate having an internal clear coat layer in addition to the clear topcoat layer to provide added protection to the metal layer.

Base Layer

A wide variety of polymer film materials are useful in the base layer of the laminates of the present invention provided that the films are metallizable. As used herein, metallizable means a layer of metal can be applied to a surface of the base layer by techniques known in the industry, and the metal layer adheres to the base layer. For example, the polymer film material may include polymers and copolymers such as polyolefins, polystyrenes, polyamides, polyesters, polycarbonates, polyvinyl alcohol, poly(ethylene vinyl alcohol), polyurethanes, polyacrylates, and fluoropolymers. In one embodiment, the polymer film material is a polyolefin, a polyester or an acrylic polymer which can be metallized.

The polyolefins which can be utilized as the base film material include polymers and copolymers of ethylene, propylene, 1-butene, etc., or blends of mixtures of such polymers and copolymers. In one embodiment the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer also are useful. In another embodiment, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Various polyethylenes which may be utilized as the base film material including low, medium, and high density polyethylenes, and mixtures thereof. An example of a low density polyethylene (LDPE) is Rexene 1017 available from Huntsman. An example of a high density polyethylene (HDPE) is Formoline LH5206 available from Formosa Plastics.

The propylene homopolymers which may be utilized as the base film material in the multilayer composites useful in the invention, either alone, or in combination with a propylene copolymer as described herein, include a variety of propylene homopolymers such as those having melt flow rates (MFR) from about 0.5 to about 20 as determined by ASTM Test D 1238. In one embodiment, propylene homopolymers having MFR's of less than 10, and more often from about 4 to about 10 are particularly useful. Useful propylene homopolymers also may be characterized as having densities in the range of from about 0.88 to about 0.92 μg cm³. A number of propylene homopolymers are available commercially from a variety of sources, and some useful polymers include: 5A97, available from Union Carbide and having a melt flow of 12.0 g/10 min and a density of 0.90 g/cm³; DX5E66, also available from Union Carbide and having an MFI of 8.8 g/10 min and a density of 0.90 g/cm³; and WRD5-1057 from Union Carbide having an MFI of 3.9 9/10 min and a density of 0.90 g/cm³. Useful commercial propylene homopolymers are also available from Fina and Montel.

Polystyrenes can also be utilized as the polymer facestock material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillips Petroleum Co. KR-10 is believed to be a copolymer of styrene with 1,3-butadiene.

Polyurethanes also can be utilized as the polymer film material, and the polyurethanes may include aliphatic as well as aromatic polyurethanes.

The polyurethanes are typically the reaction products of (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of aliphatic polyether polyurethanes include Sancure 2710® and/or Avalure UR 445®, Sancure 878®, NeoRez R-600, NeoRez R-966, NeoRez R-967, and Witcobond W-320.

In one embodiment, the base layer may comprise at least one polyester polyurethane. Examples of these urethanes include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861 ” (polyether-polyurethane) by the company Sanncor, under the names “Neorez R-974” (polyester-polyurethane), “Neorez R-981” (polyester-polyurethane) and “Neorez R-970” (polyether-polyurethane) by the company ICI, and the acrylic copolymer dispersion sold under the name “Neocryl XK-90” by the company Avecia.

Polyesters prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307 which is polyethylene terephthalate.

Acrylate polymers and copolymers and alkylene vinyl acetate resins (e.g., EVA polymers) also are useful as the film forming materials in the preparation of the base layer. Commercial examples of available polymers include Escorene UL-7520 (Exxon), a copolymer of ethylene with 19.3% vinyl acetate; Nucrell 699 (duPont), an ethylene copolymer containing 11% of methacrylic acid, etc.

Polycarbonates also are useful, and these are available from the Dow Chemical Co. (Calibre) G. E. Plastics (Lexan) and Bayer (Makrolon). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

The base layer is free of filler particles in order to provide a base layer which is clear and transparent. Small amounts of filler particles (organic or inorganic) may be included in some embodiments provided the base layer remains transparent or substantially transparent.

The thickness of the base layer may be varied over a wide range. In one embodiment, the thickness of the base layer is from about 20 to 125 microns, and in another embodiment from about 40 to 100 microns.

In some embodiments of this invention the base layer is further characterized as having smooth surfaces. Smooth surfaces are desirable for providing a mirror like finish to the laminate. In one embodiment, the surfaces of the base layer have an average surface roughness (Ra) of less than about 0.4 microns as determined by DIN (German Institute for Standardization) 4768. In other embodiments the Ra is less than about 0.1 micron.

Metal Layer

The metal layer comprises a highly reflective metal. The metal also is desirably corrosion resistant and abrasion-resistant. As used herein, the term metal layer refers to a layer that contains metal free of binders such as polymers and resins. The layer is substantially all reflective metal. The metal layer may be applied to the surface of the base layer by any of the techniques known in the art. In one embodiment, the metal layer is applied to the second surface of the base layer by vacuum deposition techniques which bond the metal to the polymeric base layer. In one embodiment, the reflective metal layer has a thickness of from about 1 to about 8 microns and in another embodiment from about 2 to 6 microns. The metal layer may be vacuum-deposited to provide a continuous metal layer although it is possible, in some instances, that the metal can be vacuum-deposited in separate planar reflective segments which are discontinuous, such as dots, but which are deposited so close together that they give the optical visual effect of a continuous, highly reflective metallized surface. Any metal which can be deposited on the second surface of the base layer and which is highly reflective can be utilized in the multilayer laminates of the present invention. Examples of reflective metals include aluminum; nickel; chromium; alloys of chromium and nickel or iron; alloys of aluminum; antimony; tin; platinum; silver; rhodium; platinum; indium and alloys of indium with nickel or tin, etc. It has been observed that aluminum provides a highly reflective surface which simulates a chrome-like product.

The Adhesive Layer(s)

The adhesive layer(s) utilized in the present invention may comprise any of a variety of adhesives known in the art and used in label applications. Typically, the adhesive layer has a thickness of from about 0.4 to about 1.6 mils (10 to about 40 microns). The adhesive may comprise any of a number of known heat-activatable or heat-seal adhesive materials. These are polymer materials which are activated and become tacky on heating. Thus, the heat-activatable adhesive layer may comprise any heat-activatable adhesive or thermoplastic film material. Such materials include but are not limited to the following film-forming materials used alone or in combination such as polyolefins, (linear or branched), metallocene catalyzed polyolefins, syndiotactic polystyrenes, syndiotactic polypropylenes, cyclic polyolefins, polyacrylates, polyethylene ethyl acrylate, polyethylene methyl acrylate, acrylonitrile butadiene styrene polymer, ethylene-vinyl alcohol copolymer, ethylene-vinyl acetate copolymers, polyamides such as nylon, polystyrenes, polyurethanes, polysulfones, polyvinylidene chlorides, polycarbonates, styrene maleic anhydride polymers, styrene acrylonitrile polymers, ionomers based on sodium or zinc salts of ethylene/methacrylic acid, cellulosics, fluoroplastics, polyacrylonitriles, and thermoplastic polyesters. More specific examples are the acrylates such as ethylene methacrylic acid, ethylene methyl acrylate, ethylene acrylic acid and ethylene ethyl acrylate. Also, included are polymers and copolymers of olefin monomers having, for example, 2 to about 12 carbon atoms, and in one embodiment 2 to about 8 carbon atoms. These include the polymers of a-olefins having from 2 to about 4 carbon atoms per molecule. These include polyethylene, polypropylene, poly-1-butene, etc. An example of a copolymer within the above definition is a copolymer of ethylene with 1-butene having from about 1 to about 10 weight percent of the 1-butene comonomer incorporated into the copolymer molecule. The polyolefins include amorphous polyolefins. The polyethylenes that are useful in the heat seal layer include those with various densities including low, medium and high density ranges. The ethylene/methyl acrylate copolymers available from Chevron under the tradename EMAC can be used. These include EMAC 2260, which has a methyl acrylate content of 24% by weight and a melt index of 2.0 grams/10 minutes @ 190° C., 2.16 Kg; and EMAC SP 2268T, which also has a methyl acrylate content of 24% by weight and a melt index of 10 grams/10 minutes @ 190° C., 2.16 Kg. Polymer film materials prepared from blends of copolymers or blends of copolymers with homopolymers are also useful.

Also, the heat activatable first adhesive layer may contain antiblock additives (such as silica, diatomaceous earth, synthetic silica, glass spheres, ceramic partides, etc.) This layer also may contain an antistatic additive (such as an amine or an amide or a derivative of a fatty acid).

The first and second adhesive layers may be in one embodiment pressure-sensitive adhesives (PSA). PSAs suitable for use in the multilayer laminates of the present invention are commonly available in the art. PSAs include silicone-based PSA adhesives and acrylic based PSAs as well as other elastomers such as natural rubber or synthetic rubber-containing polymers or copolymers of styrene, butadiene, acrylonitrile, isoprene and isobutylene. PSAs are also well known in the art, and any of the known adhesives can be used in the multilayer laminates of the present invention. In one embodiment, the PSAs are based on copolymers of acrylic acid esters, such as, for example, 2-ethyl hexyl acrylate, with polar comonomers such as acrylic acid.

In the embodiments wherein a pressure sensitive adhesive layer is in contact with and adhered to the second surface of the metal layer, the adhesive layer generally is first coated on a carrier sheet such as a release liner and dried on the release liner. Thereafter, the dried adhesive layer and liner are brought into contact with the second surface of the metal layer. The adhesive layer bonds to the second surface of the metal layer, and the release liner may be left on the PSA until just prior to application of the multilayer laminates of the present invention. The release liner provides protection to the PSA until the laminate is to be applied to a substrate.

In those embodiments containing two adhesive layers (e.g., FIGS. 4 and 9), the second PSA layer also may be applied by first casting the pressure sensitive adhesive on a smooth surfaced polyester casting sheet in a separate operation. The adhesive coat is dried to produce a smooth surface, and the adhesive coat is then laminated to the first surface of the base layer. The adhesive layer is transferred to the first surface of the base layer, and upon removal of the casting sheet, the adhesive remains adhered to the first surface of the base layer. Casting the adhesive in a separate step on a smooth polyester carrier produces a sufficiently smooth surface for the PSA layer that the DOI of the finished product is not significantly effected by the presence of the second PSA layer. In those embodiments containing a second PSA layer above and in contact with the first surface of the base layer, the PSA does not contain any, or only a small amount of filler (organic or inorganic) particles since it is desirable that the second adhesive layer is clear and transparent. Small amounts, e.g., 0.1 to 5% by weight of filler particles may be included provided the PSA layer remains transparent.

Clear Polymer Topcoat Layer

The topcoat layer, sometimes referred to as an overcoat layer, provides desirable properties to the multilayer laminate of the present invention. The presence of the clear and transparent topcoat layer protects the laminate from, for example, weather, sun, abrasion, moisture, water, etc. In addition, the transparent topcoat layer can enhance the optical properties of the multilayer laminate and can provide a glossier and richer image. The polymer topcoat layer can be applied to the multilayer laminates by techniques known to those skilled in the art. Thus, the polymer film may be deposited (direct coating) from a solution, applied as a preformed film (laminated to the structure), such as by transfer lamination, etc. In one embodiment, the thickness of the topcoat layer is in the range of from about 5 to about 50 microns (0.2 to about 2 mils). In another embodiment, the thickness of the topcoat layer is from about 15 to about 40 microns.

In one embodiment, the clear topcoat layer is a transparent thermoplastic synthetic resinous composition directly coated in thin film form in a liquid state onto the surface of another layer (e.g., base layer, tie coat layer, etc.). Heat is later applied to the clear coat to dry it. The clear topcoat produces a multilayer laminate useful as an exterior film, which, in combination with the underlying layers and, particularly the metal layer, produces a multilayer laminate having highly reflective characteristics, and these laminates are useful in exterior paint applications.

A variety of clear polymer films can be utilized as the clear topcoat layer in the multilayer laminates of the present invention. Thus, the topcoat layer may comprise polyolefins, thermoplastic polymers of ethylene and propylene, polyesters, polyurethanes, polyacrylates, polymethacrylates, polyvinyl chlorides, fluoropolymers and mixtures thereof. The polymers described as useful in the base layer can be utilized in formation of the topcoat layer provided they have the above properties described as useful in the topcoat.

In one embodiment, the clear topcoat layer comprises a mixture or an alloy of a thermoplastic fluorinated polymer and an acrylic polymer or copolymer. The clear topcoat layer may contain the fluorinated polymer and the acrylic polymer as the principal components. In one embodiment, the composition of the mixture comprises from 30 to 70% by weight of the fluorinated polymer and from 30 to 70% by weight of the acrylic polymer. In one embodiment, the fluorinated polymer component is a thermoplastic fluorocarbon resin such as polyvinylidene difluoride (PVDF). The fluorinated polymers also may include copolymers and terpolymers of vinylidene fluoride or polyvinyl fluoride, or mixtures thereof. A group of thermoplastic fluorocarbons which are useful as the topcoat layer in the multilayer laminates of the present invention are the PVDF's available from Elf Atochem under the trademark KYNAR. Generally, high molecular weight PVDF resins, with a weight average molecular weight of about 200,000 to about 600,000 can be utilized in the present invention. Specific examples of such PVDFs available from Elf Atochem include KYNAR 301 F (believed to have a weight average molecular weight (Mw) of about 465,000); KYNAR 500 (Mw=465,000); KYNAR 711 (Mw=200,000); KYNAR 741 (Mw=282,000); KYNAR 761 (Mw=444,000); KYNAR 2800 (Mw=414,000); and KYNAR 2801 (Mw=414,000).

The acrylic polymer component of the topcoat layer may be any of a variety of acrylic polymers and copolymers. Various acrylic monomers (acrylic acids and esters) can be polymerized and copolymerized with other monomers such as methacrylic acid, ethacrylic acid, methyl methacrylate, methyl ethacrylate, ethyl methacrylate, etc. In one embodiment, the acrylic polymer component of the topcoat layer can be a polymethyl methacrylate (PMMA) or a polyethyl methacrylate (PEMA) resin, or mixtures thereof, including methacrylate copolymer resins and minor amounts of other comonomers. The topcoat can also include minor amounts of block copolymers and compatibilizers to stabilize the blended PVDF and acrylic resin system, and to provide compatibility with the underlying layer.

Inhibitors, antioxidants and ultraviolet absorbers or light stabilizers also may be included in the clear topcoat formulations. Particularly useful ultraviolet absorbers, inhibitors and antioxidants include benzotriazole derivatives, hydroxy benzophenones, esters of benzoic acids, oxalic acid, diamides, etc. Various benzotriazole derivatives useful as ultraviolet absorbers and stabilizers are described in U.S. Pat. Nos. 3,004,896; 4,315,848; 4,511,596; and 4,524,165. Those portions of these patents which describe the various benzotriazole derivatives are incorporated herein by reference. Useful ultraviolet light stabilizers, inhibitors and antioxidants are available from Ciba-Geigy Corporation under the general trade designation “Tinuvin.” For example, Tinuvin 328 is described as an ultraviolet absorber which is identified as 2-(2′-hydroxy-3′,5′-di-tert-amylphenyl)benzotriazole, and Tinuvin 292 is a hindered amine light stabilizer identified as bis(1,2,2,6,6-pentamethyl-4-piperidinyl)sebacate. Tinuvin 234 is another benzotriazole UV absorber.

Antioxidants are available from Ciba-Geigy under the general trade designation “Irganox”. For example, Irganox 1010 is tetrakis [methylene (3,5-di-tert-4 hydroxycinnamate] methane. Thermolite 31 is a heat stabilizer from Elf Atochem and is believed to be dioctyl tin bis(isooctylmercaptoacetate). Cyasorb-5411 is a UV absorber available from Cytec and is believed to be 2-(2′-hydroxy-5′-octyl phenyl-)benzotriazole. The amount of antioxidant, UV stabilizer, and/or UV absorber-including in the film-forming mixtures is an amount which is effective for the intended result but does not significantly reduce the clarity of the topcoat layer. Generally, these additives may be present in film-forming mixtures in amounts of from 0 to about 10 pphr or from about 0.1 to about 5 pphr.

In one embodiment, a component of the acrylic resin contained in the topcoat layer is a medium molecular weight (MW 300,000) PEMA resin such as Elvacite 2042 (duPont). Other useful acrylic resins available under the trade designation Elvacite include Elvacite 2008 (a PMMA); Elvacite 2010, a medium molecular weight PMMA resin; Elvacite 2021, a medium-to-high molecular weight PMMA resin; Elvacite 2043 a low molecular weight PEMA resin; and mixtures of two or more such Elvacite resins. In general, the acrylic resin component has a weight average molecular weight of from about 50,000 to about 400,000.

The acrylic resin component of the clear topcoat layer is desirable because of its compatibility with PVDF in dry film form. The acrylic resin also is added in an amount that yields a transparent clear coat in dry film form. Generally speaking, transparency and DOI of the topcoat formulation increases in proportion to the amount of acrylic resin added to the PVDF-acrylic system. It has been observed that a pure PVDF clear coat has reasonably good properties, but such a coating is not normally transparent. When sufficient acrylic resin is added to the PVDF component, the resulting clear coat becomes reasonably transparent. Increased transparency of the clear topcoat layer improves the gloss level and DOI of the finished laminates of the invention. The acrylic resin is also combined with the PVDF in amounts that maintain sufficient elongation to allow the clear topcoat (and the remainder of the multilayer laminate) to be applied to complex three dimensional shapes while retaining the exterior automotive durability properties and appearance properties, including gloss and DOI. In one embodiment, the acrylic component comprises from about 30% to about 60% by weight of the total solids contained in the topcoat formulation.

The PVDF and acrylic based topcoat formulation can be prepared as a dispersion of the PVDF in a solution of the acrylic resin. In one embodiment, the topcoat formulation is prepared by mixing the acrylic resin with a suitable organic solvent and applying heat to dissolve the resin. This mixture is then cooled sufficiently before adding the PVDF component so that the PVDF will not dissolve but will be maintained as a dispersion in the acrylic-solvent based mixture. By maintaining the PVDF component as a dispersion in the topcoat, solvent evaporation during drying of the topcoat can be improved. Suitable solvents which can be used are solvents which are inert to the mixture.

The film-forming mixtures used to form the binder layer generally will contain one or more solvents which are inert to the mixture. The solvents should selected so that they will vaporize after being coated onto a surface in a thin film. Examples of solvents include esters such as ethyl acetate, butyl acetate, amyl acetate, 2-ethoxyethyl acetate, 2-(2-ethoxy)ethoxyethylacetate, 2-butoxyethyl acetate, heptyl acetate and other similar esters, hydrocarbons such as toluene and xylene, ketones, such as acetone, methyl ethyl ketone, butyrolactone, and cyclohexanone, chlorinated solvents, nitro aliphatic solvents, dioxane, etc. The amount of solvent in the film-forming mixture may be varied over a wide range such as from about 3% to about 75% by weight, more often, from about 40-75% of the solid components.

The PVDF and acrylic-based clear topcoat formulation also can be prepared as a solution of PVDF and acrylic resin in a solvent such as those listed above. In some embodiments multilayer laminates in which the topcoat layer has been prepared from a solution of PVDF in acrylic resin have demonstrated high levels of gloss and DOI.

Polymer Tie Coat

In some embodiments of the present invention, an adhesion-promoting polymer tie-coat layer may be introduced between various layers of the multilayer laminates of the present invention. The tie coat layer provides improved bonding strength and reduces the risk of delamination when the adherence of one layer to another may be insufficient. Suitable polymer tie-coat layers can be formed from compositions comprising an adhesion promoting material and, optionally, a suitable solvent. The thickness of the tie coat may be varied, and in one embodiment, the thickness is from about 0.01 to about 0.4 mil. In another embodiment the thickness of the tie coat is from about 0.04 to about 0.1 mil. The tie coat is essentially transparent so that the reflective metal layer is visible through the tie coat layer. Tie coat layers are especially useful for enhancing interlayer bonding between layers in the multilayer laminates of the present invention where the adjacent layers are comprised of different polymers. In one embodiment, useful polymer tie coat layer materials include polyolefins, polyacrylates, polyvinyl acetals such as the Butvar resins from Solutia, polyurethanes, polyesters or polyvinyl carboxylates. In one embodiment, the polymers and copolymers are derived from acrylic acid, alkyl acrylic acid, alkyl acrylic acid esters and acrylic acid esters. A variety of commercially available adhesion promoting species are available, and these are useful in the present invention. In one embodiment, the tie coat layer material may be an acrylic resin which is available from duPont under the general trade designation Elvacite. One example of such a material is Elvacite 2042 which comprises a polyethyl methacrylate (PEMA) resin with a weight average molecular weight of 300,000. Useful polyacrylates are also available from Rohm & Haas under the designation Acrylic M1-7 and from ICI under the designation Acrylic H1-7. Other commercially available adhesion promoting species useful in forming the tie-coat layer of the present invention include, for example, those known under the trade designations Formvar 7/95, Formvar 15/95, Butvar B-98 and Butvar B-72 sold by Monsanto, Mobay M-50 sold by Solutia, Vinac B-15 sold by Air Products and Lexan sold by General Electric. Other useful adhesion promoting materials useful in forming the tie-coat layers include copolymers derived from: acrylonitrile, vinylidene chloride, and acrylic acid; and polymers derived from methyl methacrylate, vinylidene chloride and itaconic acid. Suitable solvents which may be used in conjunction with the adhesion promoting species include methylethyl ketone, methylene chloride, tetrahydrofuran, toluene, methyl cellosolve, methanol, ethanol, propanol, butyanol, mixtures thereof, etc.

More than one adjacent tie coat layer may be utilized to improve the adhesion of adjacent layers in the multilayer laminates of the present invention. When more than one tie coat layer is provided, the first tie coat is dried before the second tie coat layer is applied.

In the embodiments of the present invention which are illustrated in FIGS. 2, 7 and 8, a tie coat layer is adhered to the first surface of the base layer. In those embodiments, the tie coat layer improves the adhesion between the topcoat layer and the base layer. In the embodiment illustrated in FIG. 5, the tie coat layer 55 improves the adhesion of the first surface of the base layer 51 to the second surface of the barrier layer 56. In the embodiment illustrated in FIG. 6, the tie coat layer 65 improves the adhesion between the first surface of the base layer 61 and the second surface of the ink layer 68. In the embodiment illustrated in FIG. 9, tie coat layer 95 is utilized to improve the adhesion of the first surface of the clear coat layer 99 to the second surface of the topcoat layer 94.

Some of the base layers as utilized in the present invention are available commercially with a preapplied tie coat layer. For example, a polyethylene terephthalate (PET) clear 2 mil film is available from ICI Corporation containing an acrylic tie layer on one surface of the PET film. This product is available from ICI under product number ICI 453. Another 2 mil PET film commercially with an acrylic tie layer on one surface is available from SKC Corporation under the product number SH 81.

As noted above, the tie coat layers utilized in the present invention are clear and transparent layers. Thus, the tie coat layer does not contain filler particles such as organic or inorganic fillers, or if fillers are present in the tie coat layer, they will be present in such small quantities as to not deliteriously effect the transparency of the tie coat layer.

Barrier Layer

In certain embodiments of the present invention, the multilayer laminates may contain one or more barrier layers. A barrier layer when used herein should be substantially impermeable to the migration of any migratory components in the layers on either side of the barrier layer. The term “substantially impervious” is used herein to refer to a barrier layer with at least about 90% barrier properties. In one embodiment, the barrier layer has at least about 95% barrier properties, and in a further embodiment, at least about 98%. Examples of migratory components include monomeric and polymeric plasticizers, coloring agents and other deleterious agents. Examples of plasticizers which may be included in layers comprising polyvinyl chloride include plasticizers such as monomeric plasticizers such as dioctyl phthalate and dioctyl terephthalate.

The barrier layer is essentially a continuous layer. The thickness of the barrier layer may vary over a wide range. In one embodiment, the thickness of the barrier layer is from about 2 to 10 microns. In another embodiment, the thickness is from 4 to about 8 microns.

Illustrative examples of useful barrier materials include, but are not limited to, the following: polyesters, epoxy resins, phenolic resins, polyurethanes, amino resins, acrylic resins, nylon, polyvinylidene dichloride (e.g., Saran from Dow Chemical Company), ethylene vinyl alcohol, polyvinyl fluoride, and mixtures thereof. In one embodiment, the barrier layer may be a biaxially-oriented, heat-set polyester which typically exhibits high strength, durability, weather resistance and impermeability to plasticizers, and is typically substantially dimensionally stable.

Thermosetting epoxy resins also are useful in the barrier layer and they include any of a number of well-known organic resins which are characterized by the presence therein of the epoxide group

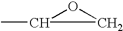

A wide variety of such resins are available commercially. Such resins have either a mixed aliphatic-aromatic or an exclusively non-benzeneoid (i.e., aliphatic or cycloaliphatic) molecular structure.

The mixed aliphatic-aromatic epoxy resins which are useful with the present invention are prepared by the well-known reaction of a bis(hydroxy-aromatic) alkane or a tetralds-(hydroxyaromatic)-alkane with a halogen-substituted aliphatic epoxide in the presence of a base such as, e.g., sodium hydroxide or potassium hydroxide. Under these conditions, hydrogen halide is first eliminated and the aliphatic epoxide group is coupled to the aromatic nucleus via an ether linkage. Then the epoxide groups condense with the hydroxyl groups to form polymeric molecules which vary in size according to the relative proportions of reactants and the reaction time.

In lieu of the epichlorohydrin, one can use halogen-substituted aliphatic epoxides containing about 4 or more carbon atoms, generally about 4 to about 20 carbon atoms. In general, it is preferred to use a chlorine-substituted terminal alkylene oxide (terminal denoting that the epoxide group is on the end of the alkyl chain) and a particular preference is expressed for epichlorohydrin by reason of its commercial availability and excellence in forming epoxy resins useful for the purpose of this invention.

If desired, the halogen-substituted aliphatic epoxide may also contain substituents such as, e.g., hydroxy keto, nitro, nitroso, ether, sulfide, carboalkoxy, etc.

Similarly, in lieu of the 2,2-bis-(p-hydroxyphenyl)-propane, one can use bis-(hydroxyaromatic) alkanes containing about 16 or more carbon atoms, generally about 16 to about 30 carbon atoms such as, e.g., 2,2-bis-(1-hydroxy-4-naphthyl)-propane; 2,2-bis(o-hydroxyphenyl)propane; 2,2-bis-(p-hydroxyphenyl) butane, 3,3-bis-(p-hydroxyphenyl)hexane; 2-(p-hydroxyphenyl)-4-(1-hydroxy-4-naphthyl)octane, 5-5-bis-(p-hydroxy-o-methylphenyl)-decane, bis-(p-hydroxyphenyl) methane,2,2-bis-(p-hydroxy-o-isopropylphenyl)propane,2,2-bis-(o,p-dihydrox yphenyl)propane, 2-(p-hydroxyphenyl)-5-(o-hydroxyphenyl)hexadecane, and the like. If desired, the bis-(hydroxyaromatic)alkane may contain substituents such as, e.g., halogen, nitro, nitroso, ether, sulfide, carboalkoxy, etc. In general, it is preferred to use a bis-(p-hydroxyphenyl)alkane since compounds of this type are readily available from the well-known condensation of phenols with aliphatic ketones or aldehydes in the presence of a dehydrating agent such as sulfuric acid. Particularly preferred is 2,2-bis-(p-hydroxyphenyl)propane, which is available commercially as “Bisphenol A”.

Epoxy resins of the type described above are available from a wide variety of commercial sources. One group is known by the general trade designation “Epon” resins and are available from Shell Chemical Co. For example, “Epon 820” is an epoxy resin having an average molecular weight of about 380 and is prepared from 2,2-bis-(p-hydroxyphenyl)propane and epichlorohydrin. Similarly, “Epon 1031” is an epoxy resin having an average molecular weight of about 616 and is prepared from epichlorohydrin and symmetrical tetrakis-(p-hydroxyphenyl)ethane. “Epon 828” has a molecular weight of 350-400 and an epoxide equivalent of about 175-210.

Another group of commercially available epoxy resins are identified under the general trade designation EPI-REZ (Celanese Resins, a Division of Celanese Coatings Company). For example, EPI-REZ 510 and EPI-REZ 509 are commercial grades of the diglycidyl ether of Bisphenol A differing slightly in viscosity and epoxide equivalent.

Another group of epoxy resins are available from Fume Plastics Inc., Los Angeles, Calif. under the general trade designations EPIBOND and EPOCAST. For example, EPIBOND 100A is a one component epoxy resin powder available from Furane which is curable to a hard resin in the absence of any hardener.

Liquid forms of epoxy resin are also useful. These liquid forms normally comprise very viscous liquids requiting some degree of heating to permit withdrawal from storage containers. Certain “D.E.R.” resins obtainable from Dow Chemical Company and “Epotuf” liquid epoxy resins obtainable from Reichhold Chemicals Inc. are examples of such resins preferred for employment in accordance with the invention. An example of an “Epotuf” liquid epoxy resin in the undiluted medium high viscosity #37-140 having an epoxide equivalent weight of 180-195, a viscosity (ASTM D445) of 11,000-14,000 cps at 25° C., and a Gardner Color Maximum of 3. This is a standard general purpose epoxy resin.

Epoxy resins such as Araldite 6010, manufactured by Ciba-Geigy or epoxy resins identified as Shell Product No. 828 can be utilized. These epoxy resins are of the glycidyl-type epoxide, and are preferably diglycidyl ethers of bis-phenol A which are derived from bis-phenol and epichlorohydrin.

In another embodiment, the barrier layer may be a radiation cured cross linked cycloaliphatic epoxide derived from at least one cycloaliphatic epoxy compound, at least one polyol and at least one photoinitiator. The barrier layer is sufficiently flexible so as to not crack, split or separate when the inventive laminate construction is bent or flexed during its normal use.

The cycloaliphatic epoxy compounds or polyepoxides that can be used are known and are described in U.S. Pat. No. 3,027,357. The portion of U.S. Pat. No. 3,027,357 beginning at column 4, line 11, to column 7, line 38, is specifically incorporated herein by reference for its disclosure of cycloaliphatic epoxy compounds that are useful. In one embodiment, diepoxides are especially useful. Examples include 3,4-epoxycyclohexylmethyl-3,4-epoxycyclohexane carboxylate, bis(3,4-epoxy-6-methylcyclohexylmethyl)adipate, bis(3,4-epoxycyclohexylmethyl)adipate, bis(2,3-epoxycyclopentyl)ether, vinyl cyclohexane diepoxide, 2-(3,4-epoxycyclohexyl)-5,5-spiro(2,3-epoxycyclohexane)-m-dioxane, and the like. A commercially available cycloaliphatic epoxy resin that is useful is available under the name Cyracure UVR-6105 or Cyracure UVR-6110, both of which are products of Union Carbide identified as 3,4-epoxycyclohexylmethyl-3,4-epoxycyclohexane carboxylate.

The polyols which may be used include glycols, alkane diols, triols, tetraols, aliphatic ether containing diols, triols, tetraols, cycloaliphatic containing diols, triols, and tetraols, and aromatic containing diols, triols, and tetraols, and the like. Examples of useful polyols include the following: ethylene glycol, diethylene glycol, 2,2,4-trimethyl-1,3-pentanediol, dipropylene glycol, propylene glycol, 2,2-dimethyl-1,3-propanediol, polypropylene glycol having an average molecular weight of about 150 to about 600 and having 2 to 4 terminal hydroxyl groups, triethylene glycol, 1,4-cyclohexanedimethanol, 2,2-dimethyl-3-hydroxypropyl 2,2-dimethyl-3-hydroxy-propionate, 1,3-butanediol, tetraethylene glycol, 2,2-bis(4-hydroxphenyl)propane, and the ethylene and propylene oxide adducts of 2,2-bis(4-hydroxypheny)propane, pentaerythritol, erythritol, glycerine, trimethylolpropane, 1 ,4-butanediol, 1,6-hexanediol, tripropylene glycol, 2,2-bis(4-hydroxycyclohexyl)propane, 1,2,6-hexanetriol, and 1,3-propanediol. The polycaprolactone esters of polyols that can be used include those in which from about 1 to about 5, and in one embodiment from about 1.5 to about 4 moles of caprolactone are esterified with a polyol such as trimethylol propane or diethylene glycol. The polycaprolactone ester of a polyol can be the polycaprolactone ester of trimethylol propane in which about 1.5 moles of caprolactone are reacted with trimethylol propane. The polycaprolactone ester of trimethylol propane where about 3.6 moles of caprolactone are esterified with trimethylol propane can be used. Also, ester diols and ester diol alkoxylates produced by the reaction of an ester diol and an alkylene oxide can be used. A commercially available polyol that is useful is available under the name Tone 0305, which is a product of Union Carbide identified as e-caprolactone triol.

The photoinitiator can be any of the aryl sulfonium salts, iodonium salts or iron hexafluorophosphate salts known in the art as being useful as photoinitiators. Commercially available aryl sulfonium salts that are useful include Cyracure UVI-6974 and Cyracure UVI-6990, both of which are products of Union Carbide, and those available from Sartomer under the names SarCat CD 1010, SarCat CD 1011 and SarCat CD 1012. The iodonium salt available from GE Silicones under the name UV 9380C is useful. Irgacure 261, which is an iron hexafluorophosphate salt available from Ciba Geigy can be used. Oxidizing agents such as cumene hydroperoxide and sensitizers such as isopropyl thioxanthone can be used to enhance cure. The amount of photoinitiator that is used is generally about 2% to about 10% by weight based on the total weight of the barrier layer composition, and in one embodiment about 6% to about 9% by weight.

Other ingredients can be added to the cycloaliphatic epoxy composition to meet specific application requirements. A variety of other epoxides can be blended with cycloaliphatic epoxides to modify viscosity, hardness, flexibility, cure rate, adhesion, and other properties. Surfactants and waxes can be used to improve substrate wetting and surface slip. Polyol additions increase flexibility and increase depth of cure of thick coatings.

The ratio of epoxide equivalents to hydroxyl equivalents (the R value) is a factor affecting properties of the barrier layer. Compositions with low R value (more hydroxyl equivalents) are typically more flexible and softer. The R value should generally be kept above about 2 to obtain hard, tack-free coatings. Increasing reactant equivalent weight makes compositions more flexible, extensible, and softer; decreasing reactant equivalent weight increases hardness and cure rate. In one embodiment, the value of R is in the range of about 2 to about 100. In another embodiment the value of R is about 2 to about 50, or from about 2 to about 10.

The cycloaliphatic epoxy composition is in the form of a liquid. It is applied to the surface of a layer of the laminate as a coating by an conventional technique known in the coating art such as roller coating, curtain coating, brushing, spraying, reverse roll coating, doctor knife, dipping, die coating, offset gravure techniques, etc. This liquid may be heated or cooled to facilitate the coating process. The applied coating can be cured by exposure to known forms of ionizing or actinic non-ionizing radiation. Useful types of radiation include ultraviolent light, electron beam, x-ray, gamma-ray, beta-ray, etc. Ultraviolet light is especially useful. The equipment for generating these forms of radiation are well known to those skilled in the art.

Polyurethane resins also are useful as films in the multilayer laminates of the present invention. Aliphatic or aromatic polyurethanes can be utilized. For example, aliphatic polyurethane resins such as Desmolac 4125, available from Mobay Chemical Company can be utilized. Desmolae 4125 is a reaction product of a cycloaliphatic isocyanate with a polyester resin and is applied in a 20% by weight solid solution in isopropanol and toluene.

The barrier layer of the present invention may comprise isoeyanate-terminated polyurethane coatings and films which may be applied as comprising an inert organic solvent and an isocyanate-terminated polyurethane and thereafter removing the solvent from the applied solution leaving the desired backcoating or film. The isocyanate-terminated polyurethane polymers are also referred to in the art as “prepolymers,” and these polymers may be formed by the reaction of selected polyols having an average molecular weight of from about 200 to about 2000 with a stoichiometric excess of an organic polyisocyanate. Such prepolymers are capable of chain extension and crosslinking (commonly called curing) with water or other chain-extending agents.

Any organic compound containing at least two active hydrogen atoms may be reacted with the stoichiometric excess of organic polyisocyanate to form an isocyanate-terminated prepolymer which is then capable of molecular weight increase by curing as described above. The prepolymers may have a free isocyanate content of from about 5% to about 20% by weight based on the prepolymer content.

Any of a wide variety of organic polyisocyanates can be employed in the formation of the polyurethane prepolymers useful in the invention. Diisocyanates are preferred, but minor amounts of other polyisocyanates can be included. The isocyanates may be aliphatic, aromatic or mixed aliphatic-aromatic isocyanates. The aliphatic and cycloaliphatic diisocyanates are preferred especially when it is preferred to have a non-yellowing urethane backcoating or film. The diisocyanates generally have from about 6 to about 40 carbon atoms, and more often from about 8 to about 20 carbon atoms in the hydrocarbon group. Suitable diisocyanates include the di(isocyanato cyclohexyl)methane, 1-isocyanato-3-isocyanatomethyl-3,3,5-trimethyl cyclohexane, hexamethylene diisocyanate, methylcyclohexyl diisocyanate, 2,4,4-trimethylhexamethylene diisocyanate, 2,6-tolylene diisocyanate, 2,4-tolylene diisocyanate, p-phenylene diisocyanate, p,p′-diphenylmethane diisocyanate, 1,5-naphthalene diisocyanate, etc. The aromatic diisocyanates usually have a lower resistance to the effects of ultra violet light.

As noted, polyols are preferred as the co-reactant in forming the prepolymers useful as coatings and films in the composites of the present invention. The polyols may be aliphatic, cycloaliphatic, aromatic or mixed structures. The polyols preferred contain a major mount of an aliphatic polyol having a molecular weight of at least about 300. These polyols are diols, including ether diols, triols including ether triols or mixtures thereof. Other polyols having greater than three hydroxy groups may also be used in conjunction with the diols and/or triols. The structure of the polyol is usually hydrocarbon in nature, but other substituents may be incorporated in the hydrocarbon moiety to effect changes in the properties of the resulting prepolymer. The molecular weights of these polyols average up to about 2000 or more but those of 300 to about 1000 average molecular weight are preferred. Examples of polyols useful in the present invention include polyoxyethylene glycols, polyoxypropylene glycols, polyoxybutylene glycols, etc. Useful monomeric glycols include ethylene glycol, propylene glycol, butene diols, 1,6-hexamethylene glycol, etc. Examples of triols include trimethylol propane, trimethylol ethane, glycerol, 1,2,6-hexane triol, etc.

Hydroxy-terminated polyester materials also are useful hydroxy reactants. Such hydroxy-terminated polyester materials can be prepared by the reaction of one or more of the polyhydroxy materials described above with one or more aliphatic, including cycloaliphatic, or aromatic polycarboxylic acids or esters, and such polyesters can often have hydroxyl values in the range of from about 25 to about 150. Examples of such acids include phthalic acid, adipic acid, sebacic acid, etc.

The isocyanate-terminated polyurethanes can be prepared by the simultaneous reaction of an excess organic polyisocyanate and polyol, or by reacting part or all of a polyol prior to reaction of the remaining amount of the material with the isoeyanate. Generally, it is preferred to add the polyisocyanate to an essentially inert organic solvent solution of polyol from which all moisture has been removed. The reaction between the polyol and the organic polyisocyanate generally is completed in about 1 to 3 hours in the absence of a catalyst. When a catalyst is used, a reaction period of about 10 minutes to about 3 hours is sufficient. When catalysts are used, they are typically organo tin compounds such as dibutyl tin dilaurate and stannous octoate. Other useful catalysts include tertiary aliphatic and alicyclic amines such as triethylamine, triethanolamine, tri-n-butylamine, etc. Mixtures of catalysts can also be employed.

The amino resins (sometimes referred to as aminoplast resins or polyalkylene amides) useful as barrier layers are nitrogen-rich polymers containing nitrogen in the amino form,—NH₂. The starting amino-bearing material is usually reacted with an aldehyde (e.g., formaldehyde) to form a reactive monomer, which is then polymerized to a thermosetting resin. Examples of amino-bearing materials include urea, melamine, copolymers of both with formaldehyde, thiourea, aniline, dicyanodiamide, toluene sulfonamide, benzoguanamine, ethylene urea and acrylamide. Preferred amino resins are the melamine-formaldehyde, melamine alkyd, and urea-formaldehyde resins.

Condensation products of other amines and amides can also be employed, for example, aldehyde condensates of triazines, diazines, triazoles, guanadines, guanamines and alkyl- and aryl-substituted derivatives of such compounds including alkyl- and aryl-substituted ureas and alkyl- and aryl-substituted melamines. Some examples of such compounds are N,N′-dimethylurea, benzourea, dicyandiamide, 2-chloro-4,6-diamino-1,3,5-triazine and 3,5-diaminotriazole. Other examples of melamine and urea-based cross-linking resins include alkylated melamine resins including methylated melamine-formaldehyde resins such as hexamethoxymethyl melamine, alkoxymethyl melamines and ureas in which the alkoxy groups have 1-4 carbon atoms such as methoxy, ethoxy, propoxy, or butoxymethyl melamines and dialkoxymethyl ureas; alkylol melamines and ureas such as hexamethylol melamine and dimethylol urea. The aminoplast cross-linking resins are particularly useful when another thermosetting resin in the aqueous composition is an alkyd resin, a polyester resin, an epoxy resin or an acrylic resin.

Melamine resins, and more particularly, melamine-formaldehyde resins may be utilized as the polymer backcoating or removable polymer film of the composite constructions of the present invention. Melamine resins which can be used include those which have been described as highly or partially methylated melamine-formaldehyde resins, high amino melamine-formaldehyde resins, mixed ether and butylated melamine-formaldehyde resins, etc.

The partially methylated melamine-formaldehyde resins generally contain a methoxymethhyl-methylol functionality such as represented by the following formula I.

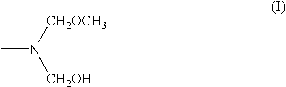

A series of such partially methylated melamine formaldehyde resins is available from American Cyanamid Company under the trade designations CYMEL 370, 373, 380 and 385 resins.

A series of highly methylated melamine resins containing a methoxymethyl functionality as represented by the following formula II.

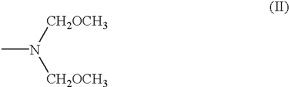

also is available from Cyanamid under the general trade designations Cymel 300, 301, 303 and 350 resins. The various resins in this series differ in their degree of 75%; alkylation and in monomer content. The monomer content in Cymel 300 is about in Cymel 301, about 70%; and Cymel 303, about 58%; and in Cymel 350, 68%.

High imino melamine resins contain methoxymethyl-imino functionalities such as may be represented by the following Formula III.

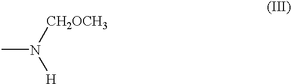

A series of melamine-formaldehyde resins known as high imino resins are available from Cyanamid under the wade designations Cymel 323, 325 and 327.

Mixed ether and butylated melamine resins are available from Cyanamid under the general trade designations Cymel 1100 resins, and these contain an alkoxy methyl functionality as illustrated by Formula IV.

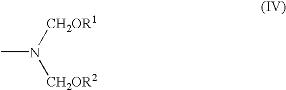

wherein R¹ and R² may be different alkyl groups such as methyl, ethyl, butyl or isobutyl groups, or both R¹ and R² may be butyl groups.

Cymel 1158 resin is a melamine formaldehyde resin available from Cyanamid which contains butoxy-imino functionality as represented by the following Formula V.

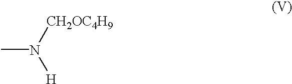

Other useful amino resins available from Cyanamid under the CYMEL® designation include benzoguanamine-formaldehyde resins (CYMEL 1123 resin), glycoluril-formaldehyde resins (CYMEL 1170, 1171 and 1172) and carboxyl-modified amino resins (CYMEL 1141 and 1125).

The acrylic resins which may be used in a barrier layer in the invention are obtained by polymerizing a suitable combination of a functional group-containing monomer and another copolymerizable monomer in an ordinary manner. The polymerization temperature is ordinarily between about 60° C. and about 100° C., and polymerization time is usually within a range of about 3 to about 10 hours. Examples of the functional group-containing monomers include hydroxyl group-containing monomers such as beta-hydroxyethyethyl acrylate, beta-hydroxypropyl acrylate, beta-hydroxyethyl methacrylate, beta-hydroxypropyl methacrylate, N-methylol acrylamide and N-methylol methacrylamide; carboxyl group-containing monomers such as acrylic acid, methacrylic acid, itaconic acid, maleic acid, fumaric acid, as well as monoesters of maleic acid and fumaric acid with monoalcohols; alkoxyl group-containing monomers such as N-butoxy-methylmethacrylamide and N-butoxymethylacrylamide; and epoxy group-containing monomers such as glycidyl methacrylate, glycidyl acrylate and allyl glycidyl ether. These monomers may be used either alone or in the form of a combination of two or more of them. The functional group-containing monomer is used in an amount of about 5 to about 40% by weight of total monomers. Examples of the monomers copolymerize with these functional group-containing monomers include olefinically unsaturated monomers such as ethylene propylene and isobutylene; aromatic monomers such as styreric, vinyl toluene and alpha-methyl styrene; ester of methacrylic acid and alcohols of 1 to about 18 carbon atoms such as methylmethacrylate, ethylmethacrylate, propylmethacrylate, n-butylmethacrylate, isobutylmethacrylate, cyclohexylmethacrylate, 2-ethylhexylmethacrylate and laurylmethacrylate; vinyl esters of carboxylic acid of about 1 to about 11 carbon atoms such as vinyl acetate, vinyl propionate and vinyl 2-ethylhexylic acid; as well as vinyl chloride, acrylonitrile and methacrylonitrile. They may be used either alone or in the form of a mixture of two or more of them.

The phenolic resins are any of the several types of synthetic thermosetting resins made by reacting a phenol, cresols, xylenols, p-t-butyl phenol p-phenyl phenol, bis-phenols and resorcinol. Examples of the aldehydes include formaldehyde, acetaldehyde and furfural. Phenol-formaldehyde resins are a preferred class of such phenolic resins.

The use of barrier layers in the multilayer laminates of the present invention is illustrated in the embodiments shown in FIGS. 3 and 5. In FIG. 3, the barrier layer 36 is positioned between the first surface of the base layer 31 and the second surface of the topcoat layer 34. Thus, for example, if the topcoat layer 34 comprises a polyvinyl chloride layer containing plasticizers, the barrier layer 36 is effective in preventing the migration of the plasticizers from the polyvinyl chloride layer 34 to the base layer 31. In FIG. 5, the barrier layer 56 is located between the first surface of the tie coat layer 55 and the second surface of the topcoat layer 54. The barrier layer 56 prevents or hinders the migration of undesirable components from the topcoat layer to the tie coat layer, and, conversely, the migration of any undesirable components from the tie coat layer 55 to the topcoat layer 54.

Clear Coat Layer

In addition to the above-described layers, the multilayer laminates of the present invention may also contain additional layers between the metal layer and the topcoat layer which are referred to herein as clear layers. The introduction of additional clear layers into the laminates of the present invention may be desirable for one or more reasons such as to obtain a thicker laminate where it is undesirable to merely increase the thickness of one or more of the other layers. As inferred from the name, the clear layer must be a clear and transparent layer and may comprise any of the polymers and copolymers identified above for use in any of the layers. Although the clear layer may contain desirable additives such as stabilizers, compatibilizers, and UV inhibitors, the layer should not contain filler particles, or if filler particles are present, they should not be present in an amount which will significantly effect the transparency of the clear layer.

Ink Layer

In one embodiment, such as the embodiment illustrated in FIG. 6, one of the layers of the multilayer laminate of the present invention may be an ink or print layer. It may be desired, in some embodiments, to form a multilayer laminate containing one or more ink layers to provide a multilayer laminate containing a desired partial coloration or words such as, for example, a trade name that will be superimposed over the reflective metal layer. In the embodiment illustrated in FIG. 6, an ink layer 68 is positioned between the topcoat layer 64 and the tie coat layer 65.

The ink layer may be a mono-colored or multi-colored ink layer. The thickness of the ink layer is typically in the range of about 0.5 to about 5 microns, and in one embodiment about 1 to about 4 microns, and in another embodiment about 3 microns. The inks used in the ink layer include commercially available water-based, solvent-based or radiation-curable, especially UV curable, inks. Examples of these inks include Sun Sheen (a product of Sun Chemical identified as an alcohol dilutable polyamide ink), Suntex MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink).

In one embodiment, the ink layer comprises a polyester/vinyl ink, a polyamide ink, an acrylic ink and/or a polyester ink. The ink layer is formed in the conventional manner by depositing, by gravure printing or the like, an ink composition comprising a resin of the type described above, a suitable pigment or dye and one or more suitable volatile solvents onto one or more desired areas of lacquer layer. After application of the ink composition, the volatile solvent component(s) of the ink composition evaporate(s), leaving only the non-volatile ink components to form the ink layer. An example of a suitable resin for use in forming a polyester ink is ViTEL® 2700 (Shell Chemical Company, Akron, Ohio)—a copolyester resin having a high tensile strength (7000 psi) and a low elongation (4% elongation). A ViTEL® 2700-based polyester ink composition may comprise 18% ViTEL® 2700, 6% pigment, 30.4% n-propyl acetate (NP Ac) and 45.6% toluene. As can readily be appreciated, ViTEL® 2700 is, by no means, the only polyester resin that may be used to formulate a polyester ink, and solvent systems, other than an NP Ac/toluene system, may be suitable for use with ViTEL® 2700, as well as with other polyester resins. An example of a polyester adhesive composition comprises 10.70%, by weight, ViTEL® 2300 polyester resin; 10.70%, by weight, ViTEL® 2700 polyester resin; 1.1%, by weight, BENZO FLEX S404 plasticizer; 1.1%, by weight, HULS 512 adhesion promoter; 19.20%, by weight, toluene; and 57.10%, by weight, methyl ethyl ketone.

The adhesion of the ink to a surface of a layer of the multilayer laminate can be improved, if necessary, by techniques well known to those skilled in the art. For example, the surface of the layer to be printed can be corona discharge treated, or a primer can be applied to the surface to be printed.

Thermoplastic Halogenated Polymer Layer

In one embodiment of the present invention, such as illustrated in FIG. 7, the multilayer laminates of the present invention may contain a polyvinyl halide layer having a first surface and a second surface wherein the first surface of the polyvinyl halide layer is in contact with the second surface of the PSA layer. In another embodiment of the invention which is illustrated in FIG. 8, the PSA layer in contact with the second surface of the metal layer such as illustrated in FIG. 1 is replaced by a polyvinyl halide layer. The thermoplastic halogenated polymer layer can be adhered to the second surface of the PSA layer in FIG. 7, and to the second surface of the metal layer such as illustrated in FIG. 8, by techniques well known to those skilled in the art such as by extrusion, lamination, etc. The thickness of this layer in one embodiment, is from about 3000 to 8000 microns (120 to 320 mils).

Various thermoplastic halogenated polymers can be utilized in the present invention, and in one embodiment, thermoplastic chlorinated polymers are utilized. An example of a useful thermoplastic chlorinated polymer is polyvinyl chloride (PVC).

Release Liner

The multilayer laminates of the invention may also comprise a release-coated liner having one surface (the release-coated surface) in contact with the otherwise exposed second surface of the adhesive layer. For example, the release coated surface of a release liner may be in contact with the second surface of the adhesive layer in FIGS. 1-6 and 9. The release liner protects the second surface of the PSA layer until the laminate is to be applied to a substrate. The use of a release liner having a smooth surface also ensures that the second surface of the outer layer (i.e., topcoat layer) of the multilayer laminate will have a smooth surface. The presence of a smooth second surface on the outer surface of the laminate enhances the DOI and gloss features of the laminates of the invention. Thus, in one embodiment, polymer films such as polyester films are particularly useful as the liner since such films (e.g., PET films) are available commercially with smooth surfaces. The surfaces of paper liners generally are not as smooth as polymer film liners.

The release-coated liner may comprise a substrate sheet of paper, polymer film or combinations thereof coated with a release composition. The typical release coating used in the industry is a silicone-based molecule which can be cured either thermally or with irradiation energy such as ultraviolet light or electron beam. Paper substrates are useful because of the wide variety of applications in which they can be employed. Paper is also relatively inexpensive and has desirable properties such as antiblocking, antistatic, dimensional stability, and can potentially be recycled. Any type of paper having sufficient tensile strength to be handled in conventional paper coating and treating apparatus can be employed as the substrate layer. Thus, any type of paper can be used depending upon the end use and particular personal preferences. Included among the types of paper which can be used is paper, clay coated paper, glassine, polymer coated paper, paperboard from straw, bark, wood, cotton, flax, cornstalks, sugarcane, bagasse, bamboo, hemp, and similar cellulose materials prepared by such processes as the soda, sulfite or sulfate processes, the neutral sulfide cooking process, alkali-chlorine processes, nitric acid processes, semi-chemical processes, etc. Although paper of any weight can be employed as a substrate material, paper having weights in the range of from about 30 to about 120 pounds per ream are useful, and papers having weights in the range of from about 60 to about 100 pounds per ream are presently preferred. The term “ream” as used herein equals 3000 square feet. Examples of specific papers which can be utilized as substrates in preparing the deposit laminates of the present invention include 41-pound offset grade bleached Kraft; 78-pound bleached Kraft paper, etc.

Alternatively, the substrate of the release-coated liner may be a polymer film, and examples of polymer films include polyolefin, polyester, polyvinyl chloride, polyvinyl fluoride (PVF), polyvinylidene difluoride (PVDF), etc., and combinations thereof. The polyolefin films may comprise polymer and copolymers of monoolefins having from 2 to 12 carbon atoms or from 2 to about 4 or 8 carbon atoms per molecule. Examples of such homopolymers include polyethylene, polypropylene, poly-1-butene, etc. The examples of copolymers within the above definition include copolymers of ethylene with from about 1% to about 10% by weight of propylene, copolymers of propylene with about 1% to about 10% by weight of ethylene or 1-butene, etc. Films prepared from blends of copolymers or blends of copolymers with homopolymers also are useful. In addition films may be extruded in mono or multilayers.

A third type of material used as a substrate for the release liner is a polycoated kraft liner which is basically comprised of a kraft liner that is coated on either one or both sides with a polymer coating. The polymer coating, which can be comprised of high, medium, or low density polyethylene, propylene, polyester, and other similar polymer films, is coated onto the substrate surface to add strength and/or dimensional stability to the liner. The weight of these types of liners ranges from 30 to 100 pounds per ream, with 40 to 94 pounds per ream representing a typical range. In total, the final liner is comprised of between 10% and 40% polymer and from 60% to 90% paper. For two sided coatings, the quantity of polymer is approximately evenly divided between the top and bottom surface of the paper.

The release coating which is contained on the substrate to form the release-coated liner may be any release coating known in the art. Silicone release coatings are particularly useful, and any of the silicone release coating compositions which are known in the art can be used. In one embodiment, it is desired to have a release coating having a smooth surface.

Properties/Performance of Laminates

The multilayer laminates of the present invention are characterized, in one embodiment, as having an exterior distinctness-of-image (DOI) value of at least about 80. In another embodiment, the multilayer laminates of the present invention have an exterior DOI value of at least about 90, and even, in some embodiments, of at least about 95. DOI is a measurement of the clarity of an image reflected by the finished surface of the multilayer laminates. DOI can be measured from the angle or reflection of a light beam from a spherical surface. The maximum DOI reading is 100 units. DOI is measured utilizing a Hunterlab Model No. D47R-6F Dorigon Gloss Meter. A test panel is placed on the instrument sensor and the sharpness of the reflected image is measured. Details of the DOI test procedure used herein are described in ASTM Test D5767-95, which is hereby incorporated by reference.

The multilayer laminates of the present invention also are characterized as having a high gloss level. In one embodiment, the multilayer laminates are characterized as having an exterior gloss level of at least about 80 gloss units measured with a 60 degree gloss meter by the procedure of ASTM Test E-340. In other embodiments, the gloss level is at least about 100 or at least about 150 gloss units. In yet another embodiment the gloss level is at least about 200 gloss units as measured with a 60 degree gloss meter. In yet another embodiment the gloss level may be up to about 500 gloss units.

In one embodiment of the present invention, the multilayer laminates may be characterized as having an optical density within the range of from about 1.8 to about 2.2. Optical densities are measured utilizing a MacBeth TR 927 densitometer, using the white filter as set forth in ASTM D-2066, method B.

In one embodiment, the multilayer laminates of the present invention also may be characterized as having one or more desirable properties such as tensile strength, elongation, adhesion to substrates, abrasion resistance and durability under various moisture and weather conditions. When the multilayer laminates of the present invention are to be utilized in automotive applications, these properties of the multilayer laminates should be sufficient to pass the various tests set forth in the GM 6073M specification. For example, according to Section 5.4 of GM 6073M, multilayer laminates prepared for automotive applications should not show any surface deterioration, objectionable shrinkage, objectionable color or gloss change, delamination, edge lifting, cracking, pitting, blistering or other degradation after exposure to the following tests: Heat aging (paragraph 6.1) thermocycling (paragraph 6.2), humidity (paragraph 6.3), Arizona and Florida exposure (paragraph 6.4), Xenon Arc apparatus (paragraph 6.5), high temperature resistance (paragraph 6.6), and ultraviolet condensation (paragraph 6.7). The test procedure set forth in these paragraphs are hereby incorporated by reference.

The following examples illustrate the preparation of multilayer laminates in accordance with the present invention. Unless otherwise indicated in the following examples, in the written description, and the appended claims, all parts and percentages are by weight, temperatures are in degrees centigrade and pressure is at or near atmospheric pressure.

### EXAMPLE 1

A high gloss, high DOI chrome-look product is prepared in the following manner. A 2 mil clear polyester (PET) film is purchased from ICI Corporation under the product number 453. In this product, the PET film is coated on one side (first surface) with an acrylic adhesion-promoting tie coat layer. The second surface of the PET film is then vacuum metallized with aluminum. The thickness of the aluminum layer is approximately 2 microns. The exposed surface of the tie coat layer is then coated with the following solvent-based mixture to deposit a clear topcoat layer. The formulation of the solvent-based mixture is as follows:

Component % By Weight

| Component | % By Weight |
|---|---|
| PVDF (Kynar 500 +) | 20.80 |
| PEMA (Elvacite 2042) | 11.20 |
| Cyclohexanone | 20.21 |
| Heptyl Acetate | 20.21 |
| Butyrolactone | 26.86 |
| Tinuvin 900 | 0.64 |
| Solsperse 17000 | 0.08 |

Solsperse 17000 is available from Zeneca Corp. and is a polymeric fatty acid ester dispersing agent.

The above solvent-based mixture is applied to the exposed surface of the tie coat layer using a reverse roll coating process. The coating thickness is about 1 mil. The coating is dried in an air circulation oven for 2 minutes at about 177° C. (350° F.).

Separately, a PSA is coated on a commercially available release-coated 2 mil PET film. The adhesive is Gelva 2837, available from the Solutia Corporation. After drying in an air circulating oven for 90 seconds, the PSA layer has a coating thickness of 30 microns (1.2 mils). As the adhesive coated, release coated PET is removed from the oven, the dried adhesive side is pressure laminated to the exposed surface of the metal layer. This results in the multilayer laminate as illustrated in FIG. 2 with the addition of the release liner in contact with the second surface of the PSA layer 23. Removal of the release liner results in a multilayer laminate shown as in FIG. 2.

The initial exterior DOI of the laminate of this Example is 99 and the 60 gloss of over 200 gloss units. When the laminate of this example is subjected to the Florida and Arizona outdoor exposure test for 12 months, there is no significant change in the gloss or the DOI of the sample. The laminate retains its mirror-like reflectance. When the laminate of this example is exposed to a XENON Weather O meter for 2500 hours, there is no significant change in the gloss or DOI of the sample.

The product of this example also is subjected to moisture resistance tests. The sample passes 240 hours at 95% plus relative humidity at 38° C. The sample also passes a deionized water immersion test at 70° C. for 72 hours. After these tests, the sample is found to have maintained its gloss and DOI. There is no noticeable corrosion of the metallized layer in the moisture resistance test.

The product of this example also passes a cross hatch adhesion test utilizing 3M 898 tape per GM test number GM9071P. When the adhesion test is performed after the water emersion test, the product passes the cross hatch adhesion test.

### EXAMPLE 2

The general procedure Example 1 is repeated except that the formulation of the polymer solution utilized to form the topcoat layer contains the following components in the amounts indicated.

| Component | % w |
|---|---|
| Polylite 2 | 45.00 |
| PVDF | 26.00 |
| Solsperse 17000 | 0.08 |
| Heptyl Acetate | 8.68 |
| Cyclohexanone | 8.68 |
| Butyrolactone | 11.56 |

Polylite 2 is a mixture of PEMA and a UV absorber in n-butyl acetate, and this material is available from Avery Dennison Corporation.

The above solvent based mixture is applied to the exposed surface of the tie coat layer using a reverse roll coating process. In this example, the coating thickness, after drying in an air circulating oven for 2 minutes at 177° C., is about 0.4 mil. The construction which results in this example is the same as in Example 1 except that the topcoat layer is thinner in this Example. The multilayer product has an initial DOI of 99+ and a 60° gloss value of over 200 gloss units.

The product of this example is subjected to the same weathering and moisture resistance test as listed in Example 1. There is no significant change in the gloss or DOI, nor is there any corrosion of the metallized layer of the multilayer laminate upon completion of the tests.

### EXAMPLE 3

A high gloss, high DOI laminate is prepared in accordance with the procedure Example 1 except that the 2 mil PET layer containing an acrylic tie-coat layer on one side is one that is purchased from SKC Corporation under the general trade designation SH 81.

While the invention has been explained in relation to its various embodiments, it is to be understood that other modifications thereof will become apparent to those skilled in the art upon reading the specification. Therefore, it is to be understood that the invention disclosed herein is intended to cover such modifications as fall within the scope of the appended claims.

1. A multilayer laminate comprising:
(A) a base layer having a first-surface and a second surface, and comprising a metallizable polymer,
(B) a metal layer having a first-surface and a second surface wherein the first surface of the metal layer is in contact with and adhered to the second surface of the base layer,
(C) a clear polymer topcoat layer having a first-surface and a second surface wherein the second surface is in contact with and adhered to the first surface of the base layer, and
(D) a first adhesive layer having a first surface and a second surface wherein the first surface of the adhesive layer is in contact with and adhered to the second surface of the metal layer.

2. The laminate of claim 1 also comprising:
(E) a polymer tie coat layer interposed between the first surface of the base layer and the second surface of the topcoat layer.

3. The laminate of claim 1 having an exterior distinctness-of-image (DOI) value of at least about 80.

4. The laminate of claim 1 having an exterior DOI value of at least about 90.

5. The laminate of claim 1 wherein the exterior DOI value is at least about 95.

6. The laminate of claim 1 having an exterior gloss level of at least about 80 measured with a 60° gloss meter.

7. The laminate of claim 1 having an exterior gloss level of at least about 200 measured with a 60° gloss meter.

8. The multilayer laminate of claim 1 also comprising a second pressure sensitive adhesive layer between the first surface of the base layer and the second surface of the clear topcoat layer.

9. The laminate of claim 1 wherein the base layer comprises at least one polymer selected from polyolefins, polyesters, polyvinyls and acrylic polymers.

10. The laminate of claim 1 wherein the base layer comprises a polyester.

11. The laminate of claim 10 wherein the polyester comprises polyethylene terepthalate.

12. The laminate of claim 1 wherein the base layer has a thickness of about 20 to about 125 microns.

13. The laminate of claim 1 wherein the clear topcoat layer comprises at least one polymer selected from halogenated polymers, polyurethanes, and acrylic polymers.

14. The laminate of claim 1 wherein the clear topcoat layer comprises an alloy of a fluoropolymer and at least one acrylic polymer.

15. The laminate of claim 1 wherein the clear topcoat layer has a thickness of about 5 to about 50 microns.

16. The laminate of claim 1 wherein the pressure sensitive adhesive layer comprises at least one silicone or acrylic pressure sensitive adhesive.

17. The laminate of claim 1 wherein the pressure sensitive adhesive layer comprises at least one acrylic pressure sensitive adhesive.

18. The laminate of claim 1 further comprising a barrier layer between the base layer and the topcoat layer.

19. The laminate of claim 18 wherein the barrier layer comprises at least one acrylic or methacrylic resin.

20. The multilayer laminate of claim 2 also comprising a ink layer between the tie coat layer and the clear topcoat layer.

21. The multilayer laminate of claim 1 wherein the metal layer comprises aluminum.

22. The multilayer laminate of claim 1 wherein the base layer is colored but is transparent.

23. The multilayer laminate of claim 1 also comprising a release coated liner in contact with the second surface of the adhesive layer.

24. A multilayer laminate having an exterior DOI value of at least 80, and comprising:
(A) a base layer having a first-surface and a second surface, and comprising a metallizable polymer,
(B) a metal layer having a first-surface and a second surface wherein the first surface of the metal layer is in contact with and adhered to the second surface of the base layer,
(C) a polymer tie coat layer having a first surface and a second surface wherein the second surface of the tie coat layer is in contact with and adhered to the first surface of the base layer,
(D) a clear polymer topcoat layer having a first surface and a second surface wherein the second surface of the clear topcoat layer is in contact with and adhered to the first surface of the tie coat layer, and
(E) a first adhesive layer having a first surface and a second surface wherein the first surface of the adhesive layer is in contact with and adhered to the second surface of the metal layer.

25. The laminate of claim 24 having a gloss level of at least about 80 measured with a 60° gloss meter.

26. The laminate of claim 24 having a gloss level of at least about 200 measured with a 60° gloss meter.

27. The laminate of claim 24 wherein the base layer comprises at least one polymer selected from polyolefins, polyesters, polyvinyls and acrylic polymers.

28. The laminate of claim 24 wherein the base layer comprises a polyester.

29. The laminate of claim 24 wherein the base layer comprises polyethylene terepthalate.

30. The laminate of claim 24 wherein the base layer has a thickness of about 1 mil to about 5 mils.

31. The laminate of claim 24 wherein the topcoat layer comprises at least one halogenated polymer.

32. The laminate of claim 24 wherein the topcoat comprises an alloy of a fluoropolymer and at least one acrylic polymer.

33. The laminate of claim 32 wherein the fluoropolymer comprises polyvinylidene difluoride.

34. The laminate of claim 24 wherein the topcoat layer comprises polyvinyl chloride.

35. The laminate of claim 24 wherein the first adhesive layer comprises at least one silicone or acrylic pressure sensitive adhesive.

36. The laminate of claim 24 wherein the first adhesive layer comprises at least one acrylic pressure sensitive adhesive.

37. The laminate of claim 34 further comprising a barrier layer between the first surface of the tie coat layer and the second surface of the topcoat layer.

38. The laminate of claim 37 wherein the barrier layer comprises at least one acrylic or methacrylic resin.

39. The laminate of claim 24 further comprising an ink layer between the tie coat layer and the topcoat layer.

40. The laminate of claim 24 wherein the base layer is colored but transparent.

41. The laminate of claim 24 further comprising a layer of thermoplastic halogenated polymer having a first surface and a second surface wherein the first surface is in contact with and adhered to the second surface of the adhesive layer.

42. The laminate of claim 24 further comprising a release liner in contact with the second surface of the adhesive layer.

43. The laminate of claim 24 wherein the exterior DOI is at least 90.

44. The laminate of claim 24 wherein the exterior DOI is at least about 95.

45. The laminate of claim 24 wherein the exterior DOI value is at least about 95 and the gloss level is at least about 200 measured with a 60° gloss meter.

46. A multilayer laminate comprising:
(A) a base layer having a first-surface and a second surface, and comprising a metallizable polymer,
(B) a metal layer having a first-surface and a second surface wherein the first surface of the metal layer is in contact with and adhered to the second surface of the base layer,
(C) a first pressure sensitive adhesive layer having a first surface and a second surface wherein the first surface of the adhesive layer is in contact with and adhered to the second surface of the metal layer,
(D) a second pressure sensitive adhesive layer having a first surface and a second surface wherein the second surface of the second pressure sensitive adhesive layer is in contact with and adhered to the first surface of the base layer,
(E) a clear polymer layer having a first surface and a second surface wherein the second surface of the clear polymer layer is in contact with and adhered to the first surface of the second pressure sensitive adhesive layer,
(F) a polymer tie coat layer having a first surface and a second surface wherein the second surface of the tie coat layer is in contact with and adhered to the first surface of the clear polymer layer, and
(G) a clear polymer topcoat layer having a first surface and a second surface wherein the second surface of the clear topcoat layer is in contact with and adhered to the first surface of the tie coat layer.

47. The multilayer laminate of claim 46 wherein the base layer comprises a polyester.

48. The multilayer laminate of claim 46 wherein the first pressure sensitive adhesive and the second pressure sensitive adhesives are acrylic adhesives.

49. The multilayer laminate of claim 46 wherein the clear coat layer comprises a thermoplastic halogenated polymer.

50. The multilayer laminate of claim 49 wherein the thermoplastic halogenated polymer is polyvinyl chloride.

51. The multilayer laminate of claim 46 wherein the clear topcoat layer comprises an alloy of a fluoropolymer and an acrylic resin.

52. The multilayer laminate of claim 51 wherein the fluoropolymer is polyvinylidene difluoride.

53. The multilayer laminate of claim 46 wherein the metal layer comprises aluminum.

54. The multilayer laminate of claim 46 wherein the tie coat layer comprises an acrylic polymer.

55. The laminate of claim 46 further comprising a release liner in contact with the second surface of the first adhesive layer.

56. The laminate of claim 46 wherein the exterior DOI of the laminate is at least 90.

57. The laminate of claim 46 having an exterior DOI of at least about 95.

58. The laminate of claim 46 having a gloss level of at least about 150 measured with a 60° gloss meter.

59. A multilayer laminate comprising:
(A) a base layer having an first-surface and a second surface, and comprising a metallizable polymer,
(B) a metal layer having a first-surface and a second surface wherein the first surface of the metal layer is in contact with and adhered to the second surface of the base layer,
(C) a layer of a thermoplastic halogenated polymer having a first surface and a second surface wherein the first surface is in contact with and adhered to the second surface of the metal layer,
(D) a polymer tie coat layer having a first surface and a second surface wherein the second surface of the tie coat layer is in contact with and adhered to the first surface of the base layer, and
(E) a clear polymer topcoat layer having an first surface and a second surface wherein the second surface of the topcoat layer is in contact with and adhered to the first surface of the tie coat layer.

60. The multilayer laminate of claim 59 wherein the layer of thermoplastic halogenated polymer comprises polyvinyl chloride.

61. The multilayer laminate of claim 59 wherein the metal layer comprises aluminum.

62. The multilayer laminate of claim 59 wherein the top coat layer comprises an alloy of a fluoropolymer and an acrylic resin.

63. The multilayer laminate of claim 62 wherein the fluoropolymer is polyvinylidene difluoride.
